(19) United States
(12) Patent Application Publication
(10) Pub. No.: US 2014/0179380 A1
(43) Pub. Date: Jun. 26, 2014

(54) METHOD AND APPARATUS FOR CONTROLLING AUDIO SIGNAL IN PORTABLE TERMINAL

(71) Applicant: Samsung Electronics Co., Ltd., Suwon-si (KR)

(72) Inventor: ByoungTack ROH, Suwon-si (KR)

(73) Assignee: Samsung Electronics Co., Ltd., Suwon-si (KR)

(21) Appl. No.: 14/134,332

(22) Filed: Dec. 19, 2013

(30) Foreign Application Priority Data
Dec. 21, 2012 (KR) 10-2012-0151206

(51) Int. Cl. H04M 1/60

(52) U.S. Cl. CPC H04M 1/6033
USPC 455/569.1

(57) ABSTRACT

A method and an apparatus for controlling an audio signal in a portable terminal are provided. The method includes determining a state of the portable terminal at a time of an activation of an audio function of the portable terminal, changing at least one audio parameter according to the determined state of the portable terminal, and processing at least one of an audio input signal and an audio output signal by applying at least one changed audio parameter.

### CROSS-REFERENCE TO RELATED APPLICATION(S)

This application claims the benefit under 35 U.S.C. §119(a) of a Korean patent application filed on Dec. 21, 2012 in the Korean Intellectual Property Office and assigned Serial No. 10-2012-0151206, the entire disclosure of which is hereby incorporated by reference.

### TECHNICAL FIELD

The present disclosure relates to a method and an apparatus for controlling an audio signal in a portable terminal. More particularly, the present disclosure relates to a method and an apparatus for controlling an audio signal in a portable terminal which appropriately changes an audio parameter according to a state of a portable terminal.

### BACKGROUND

Portable terminals provide various functions which are needed by the users. For example, a portable terminal provides various functions such as a call function, an image or a video photographing function, a broadcasting reception function, an internet access function, and other similar functions. In particular, multimedia functions have been increased in the recent portable terminals.

When providing a multimedia function, the portable terminal processes an audio signal according to a preset audio parameter, e.g., a gain and/or volume, and an equalizer. For example, the portable terminal outputs the audio signal with a volume level selected by a user. Also, the portable terminal collects the audio signal with a microphone gain which is preset according to a communication mode, a voice recognition mode, or a speaker phone call mode.

Likewise, a related-art portable terminal has a problem of not always providing an optimum audio signal to a user by processing an audio signal regardless of a type (shape, state) of the portable terminal. In particular, due to the providing of bendable and/or flexible portable terminals, the above described problems are increased. For example, due to a change in the form of the portable terminal, the position of a speaker may become more distant from a user, or when an output direction of the speaker is changed to an opposite side of the user, the user may recognize that a volume is relatively decreased. Similarly to this, due to the change in the form of the portable terminal, when a position of the microphone becomes more distant from the user, or is located in an opposite side of the portable terminal from the user, a user's voice collected through the microphone may have relatively a small gain and/or volume.

Therefore, there is a need for a method that may change an audio signal appropriately according to a type (shape, state) of the portable terminal.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and/or disadvantages and to provide at least the advantages described below. Accordingly, an aspect of the present disclosure is to provide a method and an apparatus for controlling an audio signal in a portable terminal by changing an audio parameter appropriately which is applied to an audio signal according to a type (shape, state) of the portable terminal.

Another aspect of the present disclosure is to further provide a method and an apparatus for controlling an audio signal in a portable terminal which changes an audio parameter appropriately according to a size ratio of a plurality of a split screens.

In accordance with an aspect of the present disclosure, a method for controlling an audio signal in a portable terminal is provided. The method includes determining a state of the portable terminal at a time of an activation of an audio function of the portable terminal, changing at least one audio parameter according to the determined state of the portable terminal, and processing at least one of an audio input signal and an audio output signal by applying at least one changed audio parameter.

In accordance with another aspect of the present disclosure, an apparatus for controlling an audio signal in a portable terminal is provided. The apparatus includes a sensor unit configured to sense a state of the portable terminal, a controller configured to determine a state of the portable terminal through the sensor unit at a time of audio function activation of the portable terminal, and configured to change at least one audio parameter according to the determined state of the portable terminal, an audio processing unit configured to process at least one of an audio input signal and an audio output signal by applying the at least one changed audio parameter according to the control of the controller, at least one output apparatus configured to output the audio output signal processed by the audio processing unit, and at least one input apparatus configured to collect the audio input signal.

In accordance with another aspect of the present disclosure, a non-volatile computer readable recording medium recording a program configured to cause a computer to execute an audio signal control method of a portable terminal is provided. The method includes determining a state of the portable terminal at a time of an activation of an audio function of the portable terminal, changing at least one audio parameter according to the determined state of the portable terminal, and processing at least one of an audio input signal and an audio output signal by applying the at least one changed audio parameter.

In accordance with another aspect of the present disclosure, a method for controlling an audio signal in a flexible portable terminal is provided. The method includes determining a state of the flexible portable terminal upon a change of the state of the flexible portable terminal, changing at least one audio parameter according to the determined state of the flexible portable terminal, and processing at least one of an audio input signal and an audio output signal by applying the at least one changed audio parameter to at least one of the audio input signal and the audio output signal, wherein the change of the state of the flexible portable terminal includes a change in a bending degree of the flexible portable terminal, a change of a tilting of the flexible portable terminal, a change of a direction of the flexible portable terminal, a change of a distance between a user and the flexible portable terminal, and a change in a number of display screens of the flexible portable terminal.

In accordance with another aspect of the present disclosure an apparatus for controlling an audio signal in a flexible portable terminal is provided. The apparatus includes a controller configured to determine a state of the flexible portable terminal upon a change of the state of the flexible portable terminal, and configured to change at least one audio parameter according to the determined state of the flexible portable terminal, an audio processor configured to process at least one of an audio input signal and an audio output signal by applying the at least one changed audio parameter to at least one of the audio input signal and the audio output signal, an audio output unit configured to output the processed audio output signal, and an audio input unit configured to input the audio input signal, wherein the change of the state of the flexible portable terminal includes a change in a bending degree of the flexible portable terminal, a change of a tilting of the flexible portable terminal, a change of a direction of the flexible portable terminal, a change of a distance between a user and the flexible portable terminal, and a change in a number of display screens of the flexible portable terminal.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a block diagram illustrating a configuration of a portable terminal according to an embodiment of the present disclosure;

FIG. 2 is a flow chart explaining an audio signal controlling method of a portable terminal according to an embodiment of the present disclosure;

FIG. 3 is a diagram schematically illustrating an example of a portable terminal according to an embodiment of the present disclosure;

FIG. 4 is a diagram explaining an example of controlling an audio signal according to a type of a portable terminal according to an embodiment of the present disclosure; and

FIGS. 5 and 6 are diagrams explaining an example of controlling an audio signal according to a screen ratio according to an embodiment of the present disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

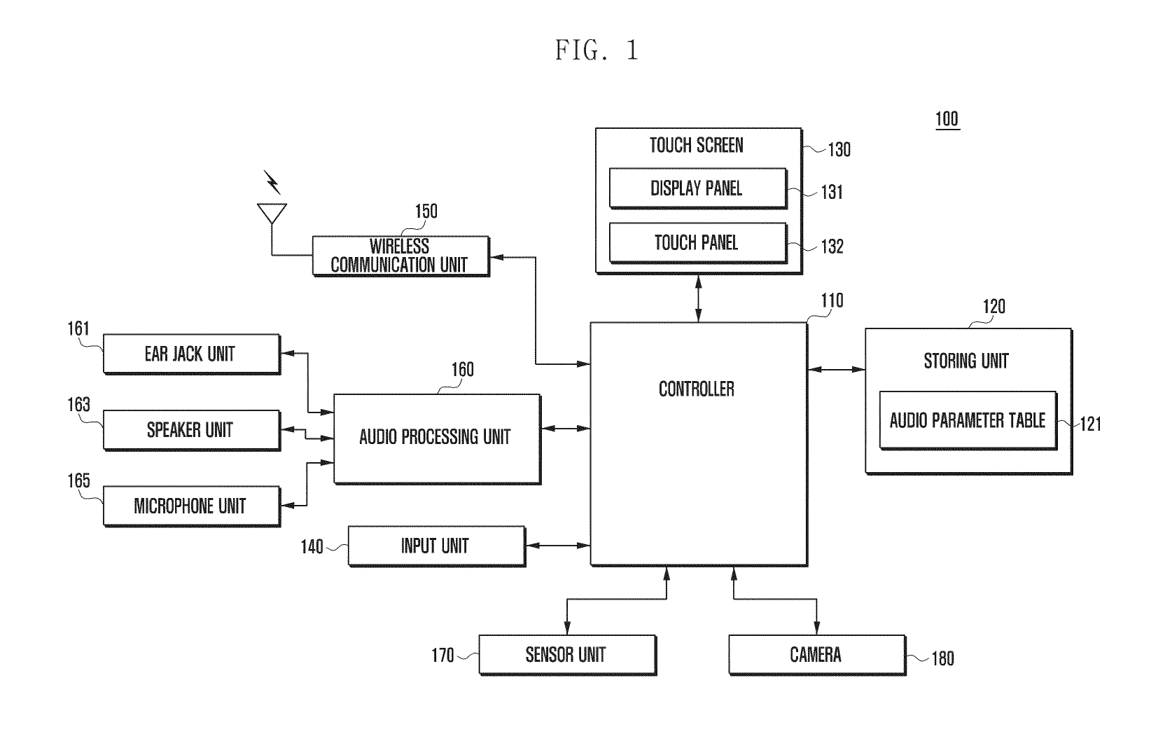

FIG. 1 is a block diagram illustrating a configuration of a portable terminal according to an embodiment of the present disclosure.

Referring to FIG. 1, a portable terminal 100, according to an embodiment of the present disclosure, may include a controller 110, a storing unit 120, a touch screen 130, an input unit 140, a wireless communication unit 150, an audio processing unit 160, a sensor unit 170, and a camera 180. The touch screen 130 includes a display panel 131 and a touch panel 132, and the storing unit 120 may include an audio parameter table 121.

The portable terminal 100 may be a mobile communication terminal, a smart phone, a Personal Computer (PC), a tablet PC, a hand-held PC, a Portable Multimedia Player (PMP), a Personal Digital Assistant (PDA), or any other similar and/or suitable electronic device. The portable terminal 100 may be formed as various types such as a bar, a slide, and a folder. In addition, the portable terminal 100 may be formed as a non-flexible type or a flexible type. Also, the portable terminal 100 may be formed partially flexible.

The portable terminal 100, according to the present disclosure, may support for an audio signal control function which dynamically changes an audio parameter of an audio signal according to a change of at least one of a state, a form, and a size change of a split screen recognized through the sensor unit 170. Hereinafter, components of the portable terminal 100 are described.

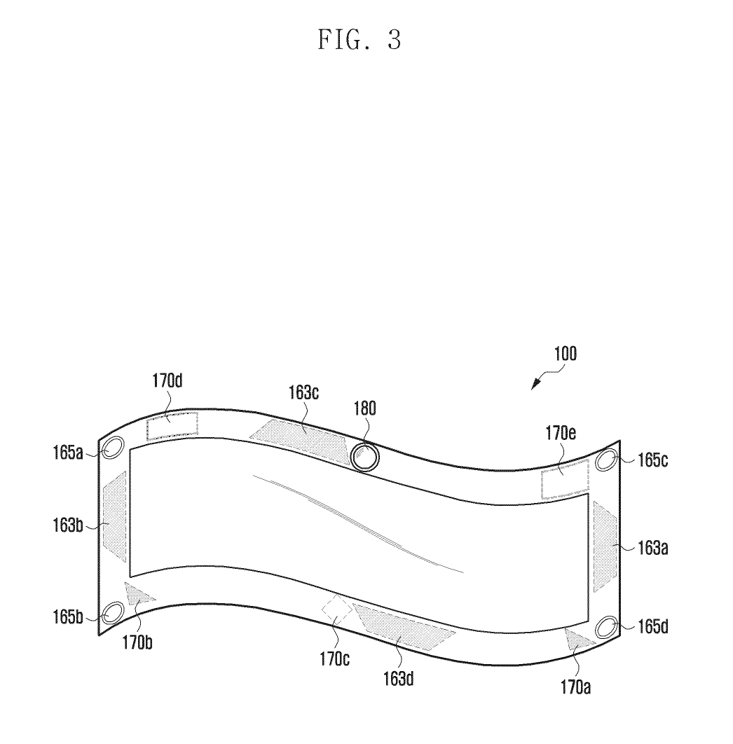

The camera 180 is an apparatus to photograph a subject, and may store a photographed image of the subject as digital data after converting the photographed image into an electrical signal. The camera 180 may be implemented by at least one of a Charge Coupled Device (CCD) image sensor, a Complementary Metal Oxide Semiconductor (CMOS) image sensor, or any other similar and/or suitable image sensor and/or image capture device. The camera 180 may support a picture photographing function and a video photographing function. In particular, the camera 180, according to the present disclosure, may photograph a subject, e.g., a user, by being activated at the time of an activation of the function, e.g., a voice call, a video call, a Voice over Long Term Evolution (VoLTE) call, a Voice over Internet Protocol (VoIP) call, a recording, a voice recognition, a music play, a video play, and a game execution, and other similar and/or suitable functions, including an audio function which inputs and/or outputs an audio signal under the control of the controller 110. The photographing information may be used in determining a direction of the portable terminal 100. The detailed description is described later with reference to FIG. 3.

The sensor unit 170 may sense a state, such as a bending, a tilting, a direction, and a distance between a user, or any other similar and/or suitable parameters and/or characteristics of the portable terminal 100. To this end, the sensor unit 170 may include a bend sensor to sense a bending degree and a bending shape of the portable terminal 100, an acceleration sensor, a motion sensor, a geomagnetic sensor, a gravity sensor, a gyroscopic sensor, a proximity sensor, a magnetic sensor to recognize a tilting, a movement and/or a direction of the portable terminal 100, an infrared sensor measuring a distance, an luminance sensor detecting a light, and any other similar and/or suitable sensor. In particular, the sensor unit 170, according to the present disclosure, transmits a sensor value corresponding to a state of the portable terminal 100 to the controller 110. The sensor unit 170 is driven at the time of an audio function activation, and may transmit information, such as the sensor value, to the controller 110 by collecting a state information of the portable terminal 100.

The audio processing unit 160 may be connected to an ear jack unit 161 and a speaker unit 163 to output an audio signal transmitted and received during a call, an audio signal included in the received message, and an audio signal according to play of the audio file stored in the storing unit 120, and a microphone unit 165 to collect a user's voice or other audio signals. In particular, the audio processing unit 160 may process the audio signal according to the state of the portable terminal 100 under the control of the controller 110. In detail, the audio processing unit 160 changes an audio parameter according to the state of the portable terminal 100, outputs the audio signal to which the changed audio parameter is applied through the ear jack unit 161 or the speaker unit 163, or may apply the changed audio parameter to the audio signal input through the microphone unit 165 and may transmit information corresponding to the changed parameter and/or the audio signal to the controller 110. When the portable terminal 100 supports a Bluetooth connection, the audio processing unit 160 may apply the audio parameter which is changed according to the state of the portable terminal 100 to the audio signal to be outputted through a Bluetooth headphone or the external speaker and may transmit the applied audio signal to the connected Bluetooth headphone or an external speaker.

Here, the audio parameter may include a gain, an Equalizer (EQ), a Bass Enhancer, a Sound Retrieval System (SRS), a sound booster, a dynamic booster, a 3 Dimensional (3D) sound, and a reverberation, and other similar and/or suitable parameters when the audio output signal is output through an output apparatus, such as a speaker, an earphone, a Bluetooth head set, an external speaker. In addition, the audio parameter may include a noise canceller, an Acoustic Echo Control (AEC), an Adaptive Gain Control (AGC), a Noise Suppression (NS), a gain, a sample rate, a codec type, and a voice enhancement when the audio input signal is input through the microphone unit 165.

The ear jack unit 161, the speaker unit 163, and the microphone unit 165 may respectively include one or more ear jack, one or more speaker, and one or more microphone. When there is a plurality of the ear jacks, the speakers, or the microphones, the audio processing unit 160 may respectively change the audio parameter with respect to a plurality of ear jacks, a plurality of speakers, or a plurality of microphones according to the state of the portable terminal 100.

The wireless communication unit 150 supports the wireless communication function of the portable terminal 100, and may include a mobile communication module, which may support any suitable type of mobile communication system and/or network, when the portable terminal 100 supports a mobile communication function. The wireless communication unit 150 may include a radio frequency transmission unit (not shown) which performs up conversion and amplification of the frequency of the transmitted signal, and a radio frequency receiving unit (not shown) which performs low noise amplification and down conversion of the frequency of received signal. In particular, the wireless communication unit 150 of the present disclosure may transmit an audio signal, such as a user's voice, which is input through the microphone unit 165 during a call, e.g., a voice call, a video call, a VoLTE call, or a VoIP call, to a base station.

Here, the transmitting audio signal is in a state in which the audio parameter is applied according to the state of the portable terminal 100. In addition, the wireless communication unit 150 may receive the audio signal, e.g., another party's voice, from a base station. The received audio signal is output through an output apparatus, such as a speaker and an earphone, after the audio parameter is applied according to the state of the portable terminal 100.

The input unit 140 receives at least one of a number and a character information and may include a plurality of input keys and the function keys to set various functions. The function keys may include an arrow key, a side key and a short key, which are set to perform a specific function. In addition, the input unit 140 generates a key signal related to a user's setting and a function control of the portable terminal 100, and delivers the key signal to the controller 110. The input unit 140 may be formed as any one of the input means such as a QWERTY keypad, a 3*4 keypad, a 4*3 keypad, a ball joystick, an optical joystick, a wheel key, a touch key, a touch pad, and a touch-screen, or may be formed as a combination of thereof.

Meanwhile, the input unit 140 may only include a volume key for a volume control, and may include at least one function key for a screen on/off function and a power on/off function, which are formed on a side of the case of the portable terminal 100 when the portable terminal 100 supports for a full touch screen. However, the present disclosure is not limited thereto, and the function keys may be disposed at any suitable location of the portable terminal 100. In particular, the input unit 140, according to the present disclosure, generates at least one of an input signal requesting an execution of an application, an input signal requesting a screen split, an input signal requesting to display another different application on a split screen, and an input signal requesting a size change of the split screen, and may transmit any of the noted input signals to the controller 110.

The touch screen 130 may provide a display function and an input function. To this end, the touch screen 130 may include the display panel 131 and the touch panel 132.

The display panel 131 displays various menus of the portable terminal 100 as well as the information input by the user and/or the information to provide to the user. For example, the display panel 131 may provide various screens according to the usage of the portable terminal 100, and the various screens may include a home screen, a message writing screen, a reception and/or a transmission text message display screen, a web page screen, a call screen, and any other similar and/or suitable screen. The display panel 131 may be formed as a Liquid Crystal Display (LCD), an Organic Light Emitted Diode (OLED) display, an Active Matrix Organic Light Emitted Diode (AMOLED) display, or any other similar and/or suitable display type. In particular, the display panel 131, according to the present disclosure, may display an application execution screen. The application may output the audio signal and/or may receive the audio signal. For example, the application may be a call application, a music play application, a video play application, a recording application, and a voice recognition application, or any other similar and/or suitable application that may output an audio signal. In addition, the display panel 131 may be split into more than two screens, and may respectively display an execution screen of the application on each split screen. Here, a size of the split screen is adjustable by the user, and the description thereof is described later. In the meantime, the display panel 131 may be formed as a flexible display panel when the portable terminal 100 is a flexible terminal.

The touch panel 132 is mounted on the display panel 131, and generates a touch event when a touch input means, for example, a user's finger, a stylus, an electrical pen, or any other similar and/or suitable touch input apparatus is touched or approached to the touch panel 132, and may deliver the generated touch event to the controller 110. In detail, the touch panel 132 determines a generation of the touch event through a change of a physical quantity, e.g., a capacitive value, a resistance value, or any other similar and/or suitable physical quantity and/or value, according to a contact and/or a proximity of a touch input means and may deliver a kind and/or a type of the generated touch events and the touch position information to the controller 110. Since such touch panel 132 is obvious to a person having ordinary skill in the art of the present disclosure, the detailed description thereof will be omitted. In particular, the touch panel 132, according to the present disclosure, generates at least one of a touch signal requesting an execution of the application, a touch signal requesting a screen split, and a touch signal requesting a size change of the split screen, and may transmit any of the above noted touch signals to the controller 110. The touch panel 132 may be formed as a flexible touch panel when the portable terminal 100 is a flexible terminal.

The storing unit 120 may store an Operating System (OS) of the portable terminal 100 and also may store other options, information and functions, for example, an application program which is used for a sound play function, an image or a video play function, and a broadcasting play function, and a user's data, and a transmitting and receiving of data. For example, the storing unit 120 may store a video file, a game file, a music file, a movie file, and any other similar and/or suitable type of file. In particular, the storing unit 120, according to the present disclosure, may store an audio parameter table 121. The audio parameter table 121 maps and stores a specific state of the portable terminal 100 and the audio parameter. In other words, a value of the audio parameter is differently mapped in the audio parameter table 121 according to a tilting, a bending degree, and a direction. Such audio parameter table 121 may be optimized through a plurality of experiments.

In addition, the audio parameter table 121 may map and store the audio parameter according to a size of the split screen. For example, when the touch screen 130 is split into a plurality of screens, the audio parameter table 121 may map and store the value of the audio parameter corresponding to the applications which are being executed on each split screen and a ratio of each split screen.

In addition, the storing unit 120 may store an audio controlling program which controls an audio signal processing according to the state of the portable terminal 100. The audio controlling program may include a state recognition routine determining a state of the portable terminal 100 by analyzing the information collected through the sensor unit 170, an extraction routine extracting an audio parameter mapped to the recognized state of the portable terminal 100 from the pre-stored audio parameter table 121, and a processing routine applying the extracted audio parameter to the input audio signal and/or the output audio signal.

The controller 110 controls an overall operation of the portable terminal 100, and controls a signal flow between the internal blocks, and the controller 110 may perform a data processing function. For example, the controller 110 may be a Central Processing Unit (CPU) and/or an Application Processor. However, the present disclosure is not limited thereto, and the controller 110 may be any suitable hardware elements, such as an Advanced RISC (Reduced Instruction Set Compute) Machine (ARM), an Integrated Circuit (IC), a computer chip, a processor, an Application Specific IC (ASIC), or any other similar and/or suitable type of hardware element that processes data.

The controller 110 determines a state of the portable terminal 100 at the time of an activation detection of an audio function, changes at least one audio parameter by referring the pre-stored audio parameter table 121, and may control an operation related to the audio signal control which processes the audio signal by applying the at least one changed audio parameter. The detailed description of such controller 110 is described later.

In the meantime, although not illustrated in FIG. 1, the portable terminal 100 may further include elements having additional functions, such as a Global Positioning System (GPS) module for a position information reception, a broadcasting reception module for a broadcasting reception, a digital music play module such as a Motion Picture Experts Group (MPEG) Audio Layer 3 (MP3) module, and an internet communication module performing an internet function. Such elements are very diverse according to a convergence trend of a digital apparatus, thus, all elements may not be described herein, however, the portable terminal 100, according to the present disclosure, may further include the elements equivalent to the above described elements.

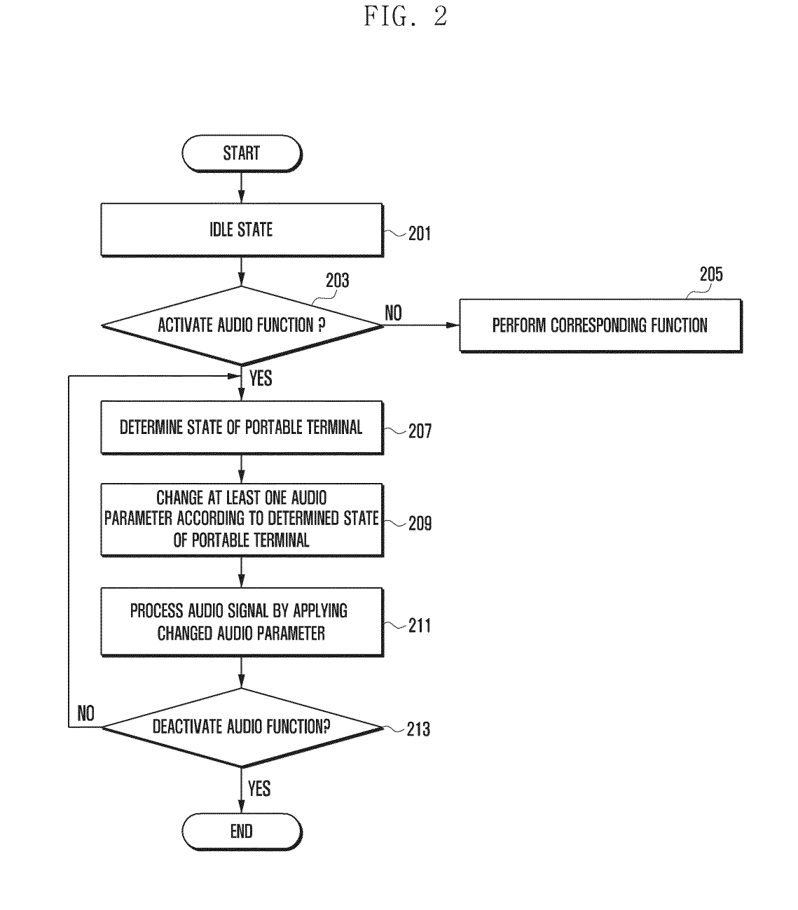

FIG. 2 is a flowchart explaining for controlling an audio signal in the portable terminal according to an embodiment of the present disclosure.

Referring to FIGS. 1 and 2, the controller 110, according to an embodiment of the present disclosure, may be in an idle state at operation 201. Next, the controller 110 may determine if an audio function is activated at operation 203. The audio function refers to a function receiving an audio signal through the microphone unit 165, and/or outputting an audio signal through an output apparatus, such as the speaker unit 163 or the ear jack unit 161. For example, the audio function may include a voice call, a video call, a VoLTE call, a VoIP call, a recording, a voice recognition, a music play, a video play, a game execution, or any other similar and/or suitable function that uses an audio signal.

When the audio function is not activated, then the controller 110 may perform the corresponding function at operation 205. For example, the controller 110 performs an internet access function, a gallery function showing the stored pictures, and a text message writing function, or may maintain an idle state according to a user's request. On the other hand, when the audio function is activated, then the controller 110 may determine a state of the portable terminal 100 at operation 207. The state of the portable terminal 100 may be determined through a sensor unit 170.

For example, the controller 110 may determine a distance between a user and the portable terminal 100 through an infrared sensor, a bending degree through a bend sensor, and the direction and the tilting of the portable terminal 100 through an acceleration sensor, a geomagnetic sensor, a gravity sensor, a luminance sensor, and a camera 180. Alternatively, the controller 110 may determine a folder to be disposed on/off of a folder type terminal and a slide position to be on/off of a slide type terminal through the geomagnetic sensor. In addition, the controller 110 may determine a size ratio of a split screen when a plurality of applications are respectively executed on a plurality of split screens.

Next, the controller 110 may change at least one audio parameter according to the determined state of the portable terminal 100 at operation 209. To this end, the storing unit 120 may store the audio parameter table 121 and may have the audio parameter table 121 pre-stored before executing operation 209.

The controller 110 may process an audio signal by applying the changed audio parameter at operation 211. That is, the controller 110 may control the audio processing unit 160 to apply and output the changed audio parameter to the audio signal, which is output to the output apparatus, such as a speaker, an ear phone, a Bluetooth headset, a wired and/or wireless media accessory, e.g., an external speaker, which may transmit and receive audio signal through various communication protocol, and the like.

Alternatively, the controller 110 may control the audio processing unit 160 to apply the changed audio parameter to the audio signal which is input through the microphone.

The controller 110 may determine if the audio function is deactivated at operation 213. When the audio function is not deactivated, then the controller 110 may return to operation 207 and may repeatedly perform the procedure described above. On the other hand, when the audio function is deactivated, then the controller 110 may terminate the audio signal controlling procedure according to the present disclosure.

As described above, the present disclosure may change the audio parameter appropriately according to the type of the portable terminal 100. As a result, the present disclosure may provide the audio function constantly, regardless of the state (shape, type) of the portable terminal 100.

Hereinabove, the present disclosure is described conceptually. Hereinafter, various embodiments in which the present disclosure may be applied are described.

FIG. 3 is a diagram schematically illustrating an example of a portable terminal according to an embodiment of the present disclosure.

Referring to FIGS. 1 to 3, the portable terminal 100, according to the present disclosure, may be a terminal formed with a flexible material. However, the present disclosure is not limited to be applied to a flexible terminal as described above, and may also be applied to a non-flexible terminal.

The portable terminal 100 may include a plurality of speakers 163a, 163b, 163c, and 163d, a plurality of microphones 165a, 165b, 165c, 165d, a camera 180, and a plurality of sensors 170a, 170b, 170c, 170d, and 170e.

The portable terminal 100 may determine an output direction of the speaker unit 163 through the camera 180. In detail, the portable terminal 100 photographs a subject through the camera 180, and may determine that a user is in a state of facing towards the portable terminal 100 when the user, and/or an eye and/or an ear of the user, is detected from the photographed image. Here, when the output direction of the speaker unit 163 and the photographing direction of the camera 180 are in the opposite direction, then the portable terminal 100 may determine that the output direction of the speaker unit 163 is in the opposite direction to the user with respect to the portable terminal 100. In such case, the portable terminal 100 may relatively increase an output level, i.e. a gain, of the speaker unit 163 as compared to the case when the output direction is in the user's side.

In addition, the portable terminal 100 may determine the direction through the camera 180 and may determine a distance to the user by analyzing the photographed image, and may control the output of the audio signal by changing a parameter according to the determined distance. For example, when a ratio of a user's face in an image captured by the camera 180 is high, then the portable terminal 100 relatively decreases the output level, i.e. the gain, of the audio signal by determining to be located closer to the user. When the ratio of a user's face is low, then the portable terminal 100 may relatively increase the output level, i.e. the gain, of the audio signal by determining to be located far from the user. In addition, the portable terminal 100 compares the sizes of both ears by analyzing the user's image photographed through the camera 180, and may control the output of the audio signal according to the comparison result. For example, when the user's right ear is relatively big, then the portable terminal 100 makes the output level of a right side speaker, which is located relatively closer to the user, less than that of a left side speaker by determining that it is deflected to the right side of the user, and may increase the output level of the left side speaker which is located relatively far from the user.

In the meantime, the portable terminal 100 may also determine whether it is disposed in a horizontal direction or a vertical direction through at least one of an acceleration sensor 170a, a geomagnetic sensor 170b, and a gyroscopic sensor 170c. However, the present disclosure is not limited thereto. For example, the portable terminal 100 may determine the direction of the portable terminal 100 by using a gravity sensor (not shown), a motion sensor (not shown), a proximity sensor (not shown), a magnetic sensor (not shown), or any other similar and/or suitable sensor.

In addition, the portable terminal 100 may measure a distance to the user through an infrared sensor 170d, and may control the output level of the speaker unit 163 according to the measured distance to the user. For example, the portable terminal 100 may increase the output level of the speaker unit 163 when the portable terminal 100 becomes farther from the user. On the other hand, the portable terminal 100 may decrease the output level of the speaker unit 163 when the portable terminal 100 becomes closer to the user. Here, the portable terminal 100 respectively measures the distance between the speakers 163a, 163b, 163c, 163d of the speaker unit 163 and a user, and may control the output level of a plurality of speakers 163a, 163b, 163c, 163d respectively according to the measured distance.

In addition, the portable terminal 100 determines the bending and the bending degree through the bending sensor 170e, and may control the audio signal according to the determined result. For example, when a first speaker 163b becomes farther from the user, and a second speaker 163a is bent to be closer to the user, then the portable terminal 100 increases the output level of the first speaker 163b, and may decrease the output level of the second speaker 163a. Therefore, the user of the portable terminal 100, according to the present disclosure, may feel that the first speaker 163b and the second speaker 163a output an identical size, level, and/or amount of the audio signal.

In addition, the portable terminal 100 may control the output level of the speaker 163 through the luminance sensor (not shown). For example, the portable terminal may have the luminance sensor disposed around the speaker unit 163, and may increase the output level of the speaker unit 163 by determining that the speaker unit 163 is obscured by a specific object when a light is not detected through the luminance sensor in a state of the audio function being activated. Here, the portable terminal 100 may control the audio parameter appropriately so that a ringing effect, due to a clogging of the speaker unit 163, is not generated.

In the meantime, the portable terminal 100 may control the audio signal, which is input from a plurality of microphones 165a, 165b, 165c, 165d, according to the state determined through the sensor unit 170 and the camera 180. For example, the portable terminal 100 may relatively decrease the gain of the activated microphone when the activated microphone, from among the plurality of microphones 165a, 165b, 165c, 165d, is located close to the user, and may relatively increases the gain of the activated microphone when the activated microphone is located far from the user. Here, the portable terminal 100 respectively measures the distance between the plurality of microphones 165a, 165b, 165c, 165d and the user, and may control the gain of a plurality of microphones 165a, 165b, 165c, 165d, respectively, according to the measured distance. Through this, the present disclosure may improve a call quality and a recording quality.

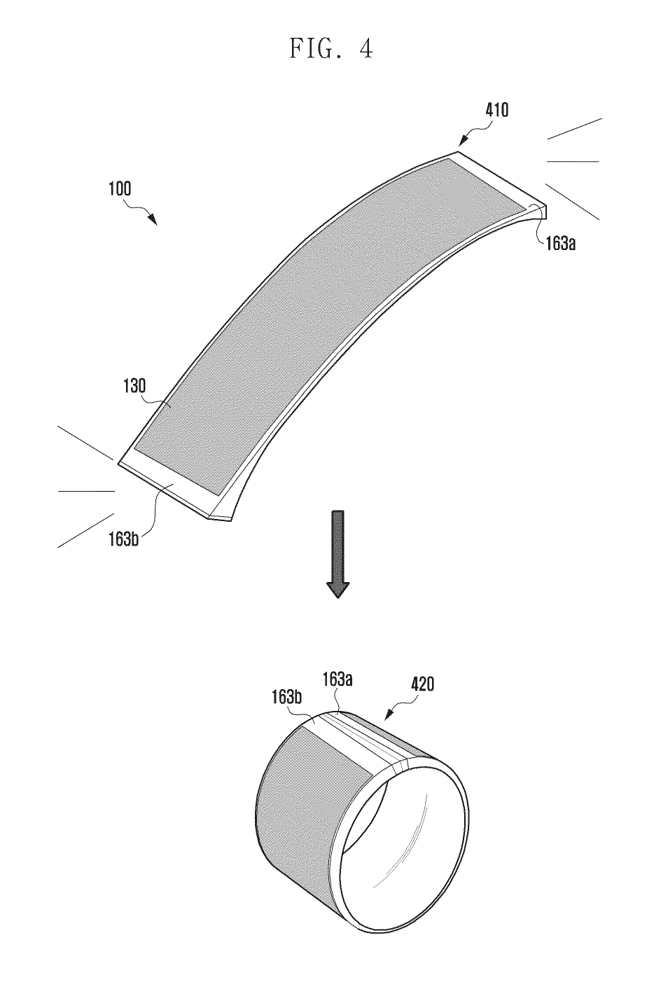

FIG. 4 is a diagram explaining an example of controlling an audio signal according to a type of the portable terminal according to an embodiment of the present disclosure.

Referring to FIGS. 1 to 4, the portable terminal 100, according to the present disclosure, is a terminal formed with a flexible material. As illustrated in FIG. 4, the portable terminal is in an unfolded state 410, which may also be referred to as a normal state, and in the unfolded state 410, the speakers 163a, 163b are located on both end sides of the touch screen 130 in the portable terminal 100.

When the portable terminal 100 is in the unfolded state 410, that is, when the speakers 163a, 163b are separated by more than a certain distance, then the controller 110 may control the audio processing unit 160 to operate the speakers 163a, 163b as a stereo. On the other hand, when the portable terminal 100 is bended and/or has a form change so as to be shaped approximately as a circle, then the portable terminal 100 is considered to be in a bended state 420, and the speakers 163a, 163b may touch each other or may be separated by less than a certain distance. Here, the controller 110 may control the audio processing unit 160 to operate the speakers 163a, 163b as one speaker, i.e. a mono speaker. This may also be applied when the portable terminal 100 includes three or more speakers.

In the meantime, in the above description, only the case of outputting the audio signal was described. However, the present disclosure may also be applied similarly when the audio signal is input. That is, the controller 110 may increase the gain of the microphone when the distance between the microphone and the user increases, and may decrease the gain of the microphone when the distance between the microphone and the user decreases.

In addition, due to a form change of the portable terminal 100, the output audio signal of the speaker is input to the microphone to generate an Acoustic Echo when the distance between the speaker and the microphone gets closer. To prevent such problem, the controller 110 may change the audio parameter of the speaker and the microphone appropriately. For example, the controller 110 decreases the output level of the speaker, and may enhance the function of at least one of a noise canceller of the microphone, an Echo canceller, and Echo Suppressor.

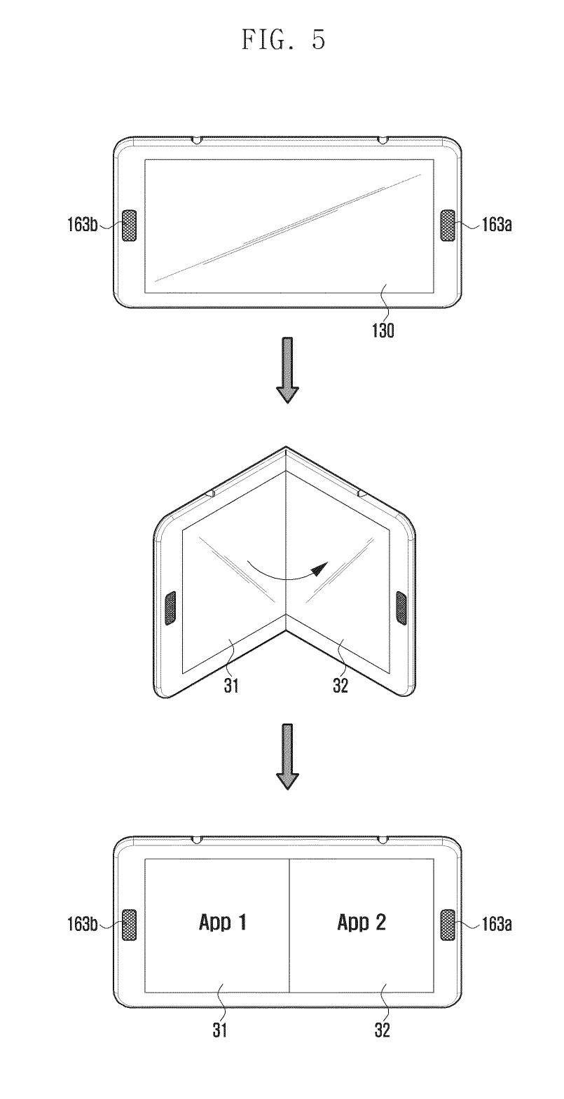

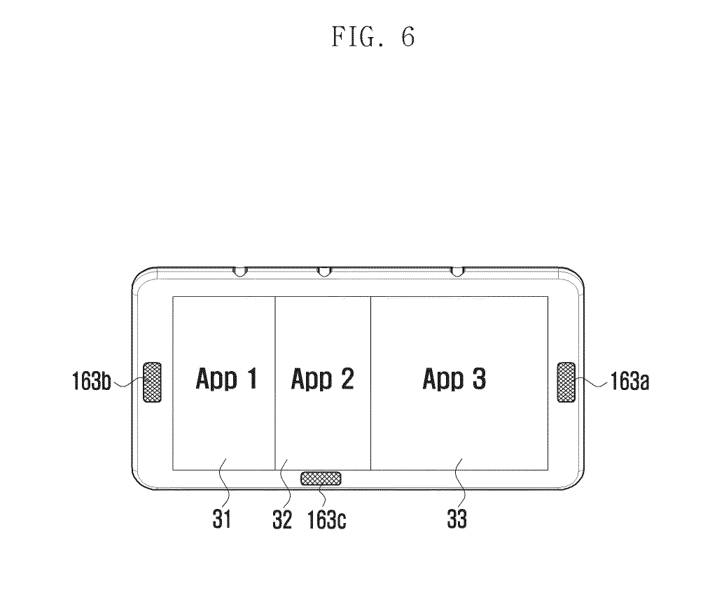

FIGS. 5 and 6 are diagrams explaining an example of controlling an audio signal according to a screen ratio according to an embodiment of the present disclosure.

Referring to FIGS. 1 to 6, the touch screen 130 of the portable terminal 100 may be split into a plurality of screens. For example, as illustrated in FIG. 5, the portable terminal 100 determines that a folding of the touch screen 130 has occurred and may split a screen based on the folding part. Alternatively, the touch screen 130 may be split through a user's gesture. For example, when the user inputs a drawing gesture which crosses the screen, then the controller 110 may split the screen based on the points where the drawing gesture is detected. Otherwise, the controller 110 may split the screen with a preset number, e.g., 2, when a screen split command is input. Here, the user may change the size of the split screen by touch and dragging one side, e.g., a width side, of the split screen. Here, when a size of one of the split screens increases, then the size of other split screens decrease relative to the increased size of the one of the split screens.

As described above, the controller 110 may control the parameter of the audio signal according to a size ratio between the split screens when the screen is split into a plurality of numbers. For example, as illustrated in FIG. 5, when the touch screen 130 is split into two screens which have identical sizes, then the controller 110 may output an audio output signal of a first application App1, which is displayed on the first screen 31, and an audio output signal of a second application App2, which is displayed on a second screen 32, with an identical output level through a first speaker 163b and a second speaker 163a. In addition, the controller 110 may control to output the audio output signal of the first application App1 through the first speaker 163b and to output the audio output signal of the second application App2 from the second speaker 163a.

On the other hand, although not illustrated in FIG. 5, when a size of the first screen 31 increases, then the controller 110 increases the output level of the audio output signal of the first application App1 and may decrease the output level of the audio output signal of the second application App2. However, when a size of the first screen 31 decreases, then the controller 110 decreases the output level of the audio output signal of the first application App1, and may increases the output level of the audio output signal of the second application App2. Here, the controller 110 may change the output level of the audio signal, as well as the audio parameter, such as an EQ and a sound boost, according to the change of the screen ratio.

In the meantime, as illustrated in FIG. 6, the touch screen is split into three screens 31, 32, 33, and when the touch screen is split into the three screens 31, 32, and 33, according to a ratio of 1:1:2, then the controller 110 may control the audio output signal of the first application App 1, which is being displayed on the first screen 31, the audio output signal of the second application App2, which is displayed on the second screen 32, and the audio output signal of a third application App3, which is displayed on the third screen 33 to have a ratio of 1:1:2.

For example, the controller 110 may maintain the output level of the audio output signal of the third application App3, and may decrease the output level of the audio output signal of the first application App1 and the audio output signal of the second application App2 to ½ of a current and/or previous output level. Here, the controller 110 may control to output the audio output signals having the ratio of 1:1:2 together through the first speaker 163b, the second speaker 163a, and a third speaker 163c. However, the present disclosure is not limited thereto, and the ratio of the audio output signals may be any suitable ratio.

Alternatively, the controller 110 may control to output the audio output signal of the first application App1 through the first speaker 163b, to output the audio output signal of the second application App2 from the third speaker 163c, and to output the audio output signal of the third application (App3) from the second speaker 163a. However, the present disclosure is not limited thereto, and the audio output signal of any application may be output from any speaker of the portable terminal 100.

As described in FIGS. 5 and 6, the reason for controlling the audio signal according to the size ratio of the split screens is because the gesture of enlarging the split screen means that user relatively has more interest in a particular one of the split screen, and thus, wants to hear the audio signal of the application which the user is interested in more loudly.

The foregoing method for controlling an audio signal in a portable terminal of the present disclosure may be implemented in an executable program command form by various computer devices and/or elements and may be recorded in a computer readable recording medium. In this case, the computer readable recording medium may be non-transient and may include a program command, a data file, and a data structure individually or a combination thereof. In the meantime, the program command recorded in a recording medium may be specially designed or configured for the present disclosure or be known to a person having ordinary skill in a computer software field to be used.

The computer readable recording medium includes Magnetic Media such as hard disk, floppy disk, or magnetic tape, Optical Media such as Compact Disc Read Only Memory (CD-ROM) or Digital Versatile Disc (DVD), Magneto-Optical Media such as floptical disk, and a hardware device such as a Read Only Memory (ROM), a Random Access Memory (RAM), and a flash memory storing and executing program commands. Further, the program command includes a machine language code created by a complier and a high-level language code executable by a computer using an interpreter. The foregoing hardware device may be configured to be operated as at least one software module to perform an operation of the present disclosure.

As described hereinabove, the method and the apparatus for controlling the audio signal in the portable terminal according to an embodiment of the present disclosure may control the audio parameter according to the type of the portable terminal. As a result, the present disclosure may provide an optimum audio effect to the user.

In addition, when a plurality of applications are executed on a plurality of split screens respectively, then the output level of the audio signal of each application may be set differently according to the respective size of split screen. As a result, the user of the present disclosure may concentrate more on the application which the user is interested in.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. A method for controlling an audio signal in a portable terminal, the method comprising:
determining a state of the portable terminal at a time of an activation of an audio function of the portable terminal;
changing at least one audio parameter according to the determined state of the portable terminal; and
processing at least one of an audio input signal and an audio output signal by applying at least one changed audio parameter.

2. The method of claim 1, wherein the determining of the state of the portable terminal comprises:
determining a bending degree of the portable terminal; and
determining at least one of a tilting, a direction, and a distance between a user and the portable terminal.

3. The method of claim 1, wherein the processing of the at least one of audio input signal and the audio output signal comprises:
outputting the audio output signal, to which the changed audio parameter is applied, through at least one output apparatus;
collecting the audio input signal through at least one input apparatus; and
applying the changed audio parameter to the collected audio signal.

4. The method of claim 3, wherein the changing of the at least one audio parameter comprises:
controlling a gain of the speaker, according to a distance between a user and the speaker, when the audio output signal is outputted through a speaker of the portable terminal; and
controlling a gain of a microphone, according to a distance between the user and a microphone, when the audio input signal is inputted through a microphone of the portable terminal.

5. The method of claim 4, wherein the controlling of the gain of the speaker comprises:
increasing the gain of the speaker, which is disposed away from a user as compared to another speaker of the portable terminal, and decreasing a gain of the other speaker, which is disposed closer to the user, so that the user determines that a plurality of speakers outputs a similar level of an audio signal, when the portable terminal includes a plurality of speakers.

6. The method of claim 1, wherein the changing of the at least one audio parameter further comprises:
measuring a size ratio of each split screen when a plurality of applications are being executed on a plurality of split screens; and
controlling an output degree of an audio signal of the plurality of applications according to the measured size ratio of each split screen.

7. The method of claim 1, wherein the changing of the at least one audio parameter comprises:
changing at least one of an audio parameter of the speaker and an audio parameter of the microphone so that an acoustic echo may be minimized when a distance between a speaker and a microphone changes according to a state determination of the portable terminal.

8. The method of claim 1, wherein the changing of the at least one audio parameter comprises:
operating the plurality of speakers as a stereo speaker when at least one of the plurality of speakers are separated by more than a certain distance; and
operating the plurality of speakers as a mono speaker when the portable terminal is bended and the plurality of speakers approach within a certain distance.

9. The method of claim 1, wherein the audio parameter comprises:
a gain, an equalizer, a base enhancement, a sound retrieval system, a sound booster, a dynamic booster, a three-dimensional sound, and an echo, for the audio output signal; and
a noise canceller, an Acoustic Echo Control (AEC), an Adaptive Gain Control (AGC), a Noise Suppression (NS), a gain, a sample rate, a kind of codec, and a voice enhancement for the audio input signal.

10. An apparatus for controlling an audio signal in a portable terminal, the apparatus comprising:
a sensor unit configured to sense a state of the portable terminal;
a controller configured to determine a state of the portable terminal through the sensor unit at a time of audio function activation of the portable terminal, and configured to change at least one audio parameter according to the determined state of the portable terminal;
an audio processing unit configured to process at least one of an audio input signal and an audio output signal by applying the at least one changed audio parameter according to the control of the controller;
at least one output apparatus configured to output the audio output signal processed by the audio processing unit; and
at least one input apparatus configured to collect the audio input signal.

11. The apparatus of claim 10, further comprising:
a camera configured to photograph a subject,
wherein the controller is configured to determine an output direction of a speaker, from among the output apparatus, by analyzing a photographed image photographed through the camera.

12. The apparatus of claim 10, wherein the sensor unit includes at least one of a bending sensor, an acceleration sensor, a motion sensor, a geomagnetic sensor, a gravity sensor, a gyroscopic sensor, a proximity sensor, a magnetic sensor, an infrared sensor, and a luminance sensor.

13. The apparatus of claim 12, wherein the controller is configured to measure a distance to a user through the infrared sensor, and
wherein the controller is configured to control at least one gain from among gains of the at least one output apparatus and the at least one input apparatus according to the measured distance to user.

14. The apparatus of claim 13, wherein the controller is configured to increase a gain of the speaker, which is disposed away from a user as compared to another speaker of the portable terminal, and is configured to decrease a gain of the other speaker, which is disposed closer to the user, so that the user determines that the plurality of speakers output an audio signal having a similar magnitude when the portable terminal includes a plurality of speakers.

15. The apparatus of claim 10, further comprising a touch screen which is split into a plurality of screens,
wherein the controller is configured to measure a size ratio of the plurality of split screens when a plurality of applications are being respectively executed on the plurality of split screens, and is configured to control an output level of an audio signal of the plurality of applications according to the measured size ratio.

16. The apparatus of claim 10, wherein the output apparatus includes a speaker,
wherein the input apparatus includes a microphone, and
wherein the controller is configured to change an audio parameter of the speaker and an audio parameter of the microphone so that an acoustic echo may be minimized when a change of a distance between the speaker and the microphone is determined to have occurred by the sensor unit.

17. The apparatus of claim 10, wherein the portable terminal is formed of a flexible material,
wherein the controller is configured to operate the plurality of speakers as a stereo speaker when at least one of the plurality of speakers are separated by more than a certain distance, and
wherein the controller is configured to operate the plurality of speakers as a mono speaker when the portable terminal is bent and the plurality of speakers approach within a certain distance.

18. The apparatus of claim 10, wherein the audio parameter comprises:
a gain, an equalizer, a base enhancement, a sound retrieval system, a sound booster, a dynamic booster, a three-dimensional sound, and an echo for the audio output signal; and
a noise canceller, an Acoustic Echo Control (AEC), an Adaptive Gain Control (AGC), a Noise Suppression (NS), a gain, a sample rate, a codec kind, and a voice enhancement for the audio input signal.

19. A non-volatile computer readable recording medium recording a program configured to cause a computer to execute an audio signal control method of a portable terminal, the method comprising:
determining a state of the portable terminal at a time of an activation of an audio function of the portable terminal;
changing at least one audio parameter according to the determined state of the portable terminal; and
processing at least one of an audio input signal and an audio output signal by applying the at least one changed audio parameter.
